(19) United States
(12) Patent Application Publication
(10) Pub. No.: US 2025/0192652 A1
(43) Pub. Date: Jun. 12, 2025

(54) WINDING APPARATUS FOR A ROTOR CORE

(71) Applicants: HYUNDAI MOTOR COMPANY, Seoul (KR); KIA CORPORATION, Seoul (KR)

(72) Inventor: Seungkyu Jang, Suwon-si (KR)

(73) Assignees: HYUNDAI MOTOR COMPANY, Seoul (KR); KIA CORPORATION, Seoul (KR)

(21) Appl. No.: 18/659,280

(22) Filed: May 9, 2024

(30) Foreign Application Priority Data
Dec. 7, 2023 (KR) 10-2023-0176475

(51) Int. Cl. H02K 15/03; B65H 18/02; B65H 18/10; B65H 23/195; H02K 1/276; H02K 1/28

(52) U.S. Cl. CPC H02K 15/03; B65H 18/028; B65H 18/103; B65H 23/1955; B65H 2301/41352; H02K 1/276; H02K 1/28

(57) ABSTRACT

A winding apparatus for a rotor core may include a fiber unwinder that unwinds a fiber material for winding the rotor core. The winding apparatus may include a plurality of guide roller assemblies that guide the fiber material unwound from the fiber unwinder to the rotor core. The winding apparatus may include a tension roller assembly that is provided between the plurality of guide roller assemblies and measures a tension of the fiber material. The winding apparatus may include a core support that is provided so that the rotor core is rotatable with respect to a core shaft, the rotor core is movable in an axial direction of the core shaft, and the rotor core is tilted with respect to the core shaft.

### CROSS-REFERENCE TO RELATED APPLICATION

This application claims priority to and the benefit of Korean Patent Application No. 10-2023-0176475 filed in the Korean Intellectual Property Office on Dec. 7, 2023, the entire contents of which are incorporated herein by reference.

### BACKGROUND

### (a) Field of the Disclosure

The present disclosure relates to a winding apparatus of a rotor core.

### (b) Description of the Related Art

Generally, in a drive motor used as a drive source for an electric vehicle, a magnet, which generates magnetic force, is inserted into a rotor core. The magnet inserted into the rotor core is fixed through molding.

However, when the magnet is formed integrally with the rotor core, a problem arises in which a magnetic flux generated by the magnet leaks.

The above information disclosed in this Background section is only to enhance understanding of the background of the present disclosure. Therefore, the Background section may contain information that does not form the prior art that is already known to a person of ordinary skill in the art.

### SUMMARY

The present disclosure aims to provide a winding apparatus of a rotor core capable of preventing a magnetic flux from leaking from a magnet inserted into the rotor core.

According to an embodiment of the present disclosure, a winding apparatus of a rotor core may include a fiber unwinder that unwinds a fiber material for winding the rotor core. The winding apparatus may include a plurality of guide roller assemblies that guide the fiber material unwound from the fiber unwinder to the rotor core. The winding apparatus may include a tension roller assembly that is provided between the plurality of guide roller assemblies and measures a tension of the fiber material. The winding apparatus may include a core support that is provided so that the rotor core is rotatable with respect to a core shaft, the rotor core is movable provided in an axial direction of the core shaft, and the rotor core is tilted with respect to the core shaft.

In some embodiments, the fiber unwinder may include a material roller that is rotatably provided on a material rotation shaft and wound with a fiber material; a drive motor that rotates the material roller and may include a material bearing that supports the material rotation shaft on both sides of the material rotation shaft.

In some embodiments, the guide roller assemblies may include a first guide roller assembly that is provided downstream of the fiber unwinder and guides the fiber material unwound from the fiber unwinder. The guide roller assemblies may include a second guide roller assembly that is provided downstream of the first guide roller assembly and guides the fiber material passing through the first guide roller assembly. The guide roller assemblies may include a third guide roller assembly that is provided downstream of the second guide roller assembly and guides the fiber material passing through the second guide roller assembly to the rotor core.

In some embodiments, a third guide roller of the third guide roller assembly may be formed in a cylindrical shape whose diameter becomes smaller toward a center.

In some embodiments, a tension roller assembly may be provided between the first guide roller assembly and the second guide roller assembly.

In some embodiments, the tension roller assembly may include a load cell that measures the tension of the fiber material.

In some embodiments, the tension roller assembly may include a tension roller, side supports that support both sides of the tension roller assembly, and a lower support that supports the tension roller assembly and each of the side supports from a bottom. The tension roller assembly and the side support may be detachably assembled to the lower support.

In some embodiments, the core support may include a rotating device that rotates the rotor core with respect to the core shaft, a tilting device that tilts the rotor core with respect to the core shaft, and a moving device that moves the rotor core along the core shaft.

In some embodiments, the rotating device may include a pair of side supports that rotatably support both ends of the core shaft and a first driving unit that generates power to rotate the core shaft.

In some embodiments, each of the side supports may include a guide bearing that rotatably supports a lower portion of the core shaft.

In some embodiments, the core support may further include a pair of side supports; and an upper support plate on which the first driving unit is mounted.

In some embodiments, the tilting device may include a hinge that is provided under one side of the upper support plate. The tilting device may include a cam block that is provided under the other side of the upper support plate and has a set inclination. The tilting device may include a cam follower bearing that is movably provided between the upper support plate and the cam block. The tilting device may include a second driving unit that generates power to move the cam follower bearing.

In some embodiments, the moving device may include a linear motion guide. A lower support plate may be fixedly mounted on the linear motion guide. The tilting device may be mounted on the lower support plate. The moving device may include a linear motion block on which the linear motion guide is movably installed. The moving device may include a third driving unit that generates power to move the lower support plate along the core shaft.

In some embodiments, a rotational speed of a drive motor may be adjusted based on the tension of the fiber material measured at the tension roller assembly.

According to embodiments, by winding the entire outer surface of the rotor core with the fiber material of appropriate tension, it is possible to increase the surface tension of the rotor core and prevent the magnetic flux of the magnet inserted into the rotor core from leaking to the outside.

In addition, by minimizing the magnetic flux leaking from the rotor core, it is possible to increase the torque density of the motor and implement the high-performance motor.

Other effects that may be obtained or are predicted by an embodiment of the present disclosure are explicitly or implicitly described in a detailed description of the present disclosure. In other words, various effects that are predicted according to the present disclosure are described in the following detailed description.

### BRIEF DESCRIPTION OF THE DRAWINGS

Since the accompanying drawings are provided only to describe embodiments of the present disclosure, the spirit and scope of the present disclosure should not be interpreted as being limited to the accompanying drawings.

FIG. 1 is a partial plan view illustrating a configuration of a rotor core according to an embodiment.

FIGS. 2 and 3 are perspective views illustrating a configuration of a winding apparatus of a rotor core according to an embodiment.

FIG. 4 is a side view illustrating the configuration of the winding apparatus of a rotor core according to the embodiment.

FIG. 5 is a block diagram illustrating the configuration of the winding apparatus of a rotor core according to the embodiment.

FIG. 6 is a diagram for describing a fiber unwinder according to an embodiment.

FIG. 7 is a perspective view illustrating a configuration of a first guide roller assembly according to an embodiment.

FIG. 8 is a perspective view illustrating a configuration of a second guide roller assembly according to an embodiment.

FIG. 9 is a perspective view illustrating a configuration of a third guide roller assembly according to an embodiment.

FIG. 10 is a perspective view illustrating a configuration of a tension roller assembly according to an embodiment.

FIG. 11 is a side view illustrating the configuration of the tension roller assembly according to the embodiment.

FIG. 12 is a diagram for describing a core support according to the embodiment.

FIG. 13 is a flowchart for describing an operation of the winding apparatus of a rotor core according to the embodiment.

It should be understood that the drawings referenced above are not necessarily drawn to scale, and the drawings may present rather simplified representations of various features illustrating the basic principles of the present disclosure. For example, specific design features of the present disclosure, including specific dimensions, direction, position, and shape, will be determined in part by specific intended applications and use environments.

### DETAILED DESCRIPTION OF THE EMBODIMENTS

The terminology used herein is for the purpose of describing particular embodiments only and is not intended to limit the present disclosure. As used herein, singular forms are intended to also include plural forms, unless the context clearly dictates otherwise. The terms “comprises” and/or “comprising” specify the cited features, integers, steps, operations, elements, and/or the presence of components when used herein, but it should also be understood that these terms do not exclude the presence or addition of one or more of other features, integers, steps, operations, elements, components, and/or groups thereof. As used herein, the term “and/or” includes any one of a list of items or all combinations of the associated listed items.

Embodiments of the present disclosure are described in detail with reference to the accompanying drawings so that those having ordinary skill in the art to which the present disclosure pertains may easily practice the present disclosure. However, the present disclosure may be modified in various different forms and is not limited to embodiments provided in the present disclosure.

For clear description of the present disclosure, parts irrelevant to the description are omitted, and the same reference numerals are attached to the same or similar components throughout the present disclosure.

In addition, the size and thickness of each component illustrated in the drawings are arbitrarily illustrated for convenience of description. Thus, the present disclosure is not necessarily limited to what is illustrated in the drawings, and the thickness is enlarged to clearly express various parts and areas.

The suffixes “module” and/or “unit” for components used in the following description are given or mixed in consideration of only the ease of writing of the specification and therefore does not have meanings or roles that distinguish from each other in themselves.

Further, in describing the disclosed embodiments, where it has been determined that a detailed description for the known art related to the present disclosure may have obscured the gist of the embodiments disclosed in the present disclosure, the detailed description has been omitted.

Further, it should be understood that the accompanying drawings are provided only in order to allow embodiments of the present disclosure to be understood. The spirit and scope of the present disclosure are not limited by the accompanying drawings. The embodiments include all the modifications, equivalents, and substitutions included in the spirit and the scope of the present disclosure.

Terms including an ordinal number, such as first, second, etc., may be used to describe various components, but the components are not limited to these terms.

In the following description, an expression written in singular may be construed in singular or plural unless an explicit expression, such as “one” or “single,” is used. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

The above terms are used solely for the purpose of distinguishing one component from another.

Hereinafter, a winding apparatus of a rotor core according to an embodiment is described in detail with reference to the attached drawings.

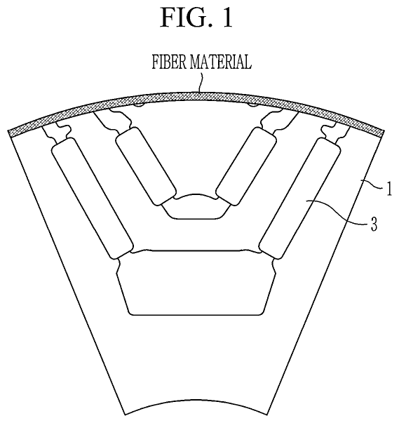

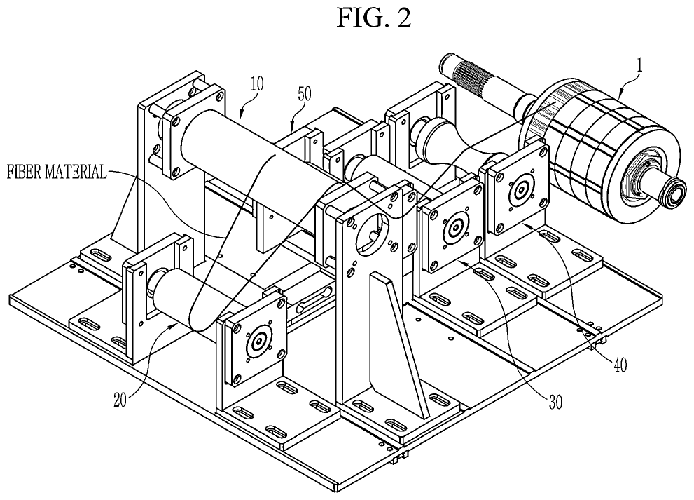

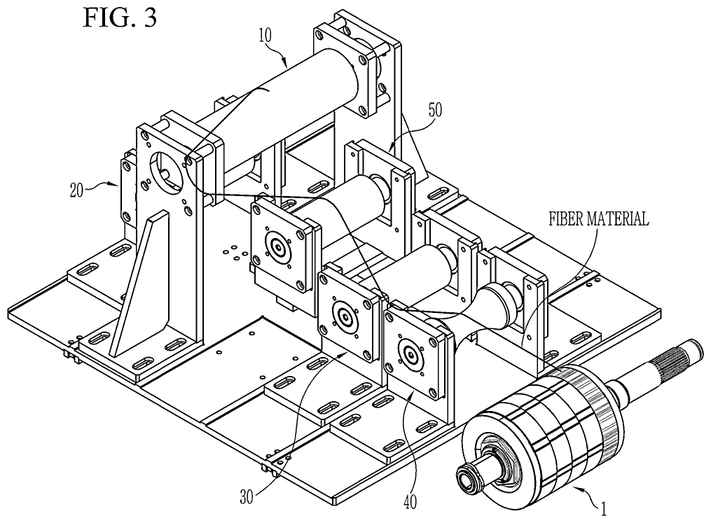

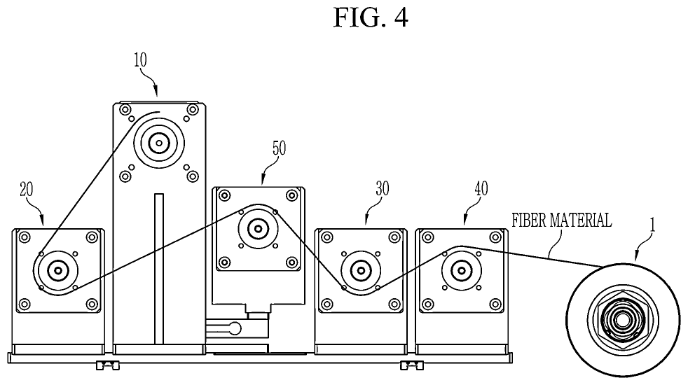

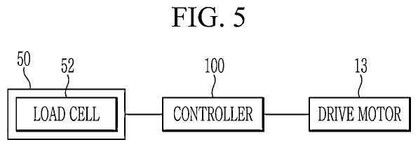

FIG. 1 is a partial plan view illustrating a configuration of a rotor core according to an embodiment. FIGS. 2 and 3 are perspective views illustrating a configuration of a winding apparatus of a rotor core according to an embodiment. FIG. 4 is a side view illustrating the configuration of the winding apparatus of a rotor core according to the embodiment. FIG. 5 is a block diagram illustrating the configuration of the winding apparatus of a rotor core according to the embodiment.

Referring to FIG. 1, a magnet 3, which generates magnetic force, is inserted into a rotor core 1 according to an embodiment, and a separation of the magnet 3 may be prevented by winding an outer surface with a fiber material.

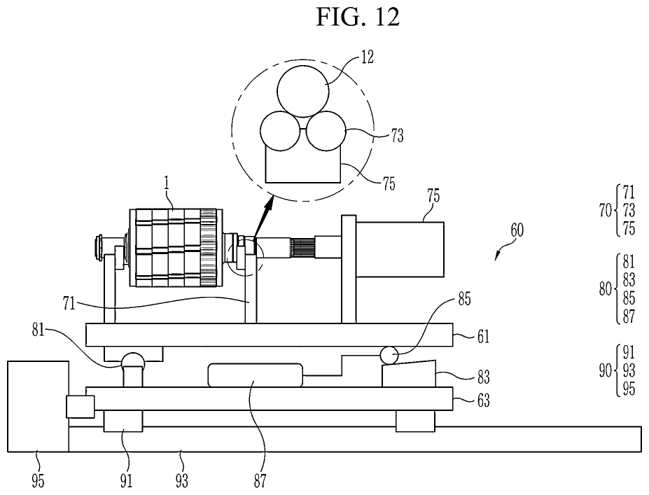

As illustrated in FIGS. 2-5, the winding apparatus of a rotor core 1 according to an embodiment may include a fiber unwinder 10 on which a fiber material for winding the rotor core 1 is wound. The winding apparatus of the rotor core 1 may also include a plurality of guide roller assemblies that guide the fiber material unwound from the fiber unwinder 10 to the rotor core 1. The winding apparatus may also include a tension roller assembly 50 that is provided between the plurality of guide roller assemblies. The winding apparatus may also include a core support 60 (as shown in FIG. 12). In the core support 60, the rotor core 1 is rotatably provided with respect to a core shaft, the rotor core 1 is movably provided in an axial direction of the core shaft, and the rotor core 1 is tilted with respect to the core shaft.

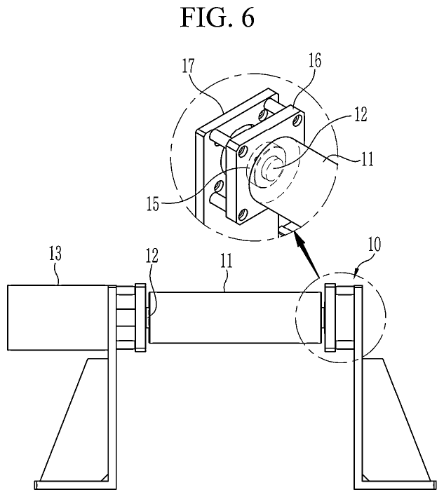

Referring to FIG. 6, the fiber unwinder 10 may include a material roller 11, a drive motor 13, and a material bearing 15.

The material roller 11 is rotatably provided on a material rotation shaft 12 and wound with the fiber material. When the material rotates, the fiber material is transported to the guide roller assembly while being unwound. The fiber material may prevent the magnet 3 inserted into the rotor core 1 from being separated by winding an outer surface of the rotor core 1. The fiber material may be carbon fiber reinforced plastics (CFRP) or glass fiber reinforced plastics (GFRP).

The drive motor 13 is connected to the material rotation shaft 12 and generates power to rotate the material roller 11. The drive motor 13 may be an electric motor.

The material bearing 15 rotatably supports the material rotation shaft 12 on an opposite side of the drive motor 13. The material bearing 15 may be fastened to an unwinder support 17 through a bearing plate 16.

In this way, since the material bearing 15 rotatably supports one side of the material rotation shaft, the material roller 11 may be easily assembled and disassembled by separating only the bearing plate 16.

A plurality of guide roller assemblies guides the fiber material unwound from the fiber unwinder 10 to the rotor core 1. In other words, the plurality of guide rollers guides the fiber material transported from the fiber unwinder 10 to the rotor core 1 so that the fiber material is transported to the correct position while maintaining appropriate tension.

The plurality of guide rollers may sequentially include a first guide roller assembly 20, a second guide roller assembly 30, and a third guide roller assembly 40.

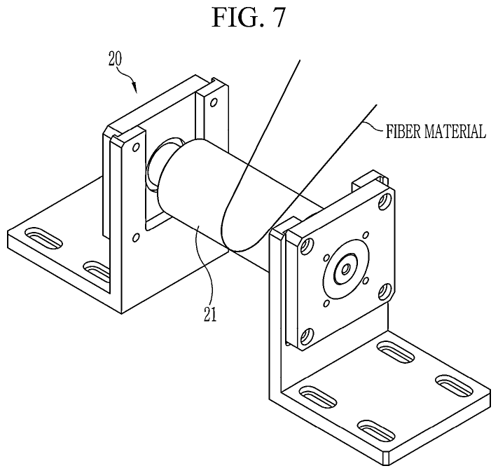

Referring to FIGS. 7-9, the first guide roller assembly 20 may be disposed downstream of the fiber unwinder 10, the second guide roller assembly 30 may be disposed downstream of the first guide roller assembly 20, and the third guide roller assembly 40 may be disposed downstream of the second guide roller assembly 30.

The first guide roller assembly 20 guides the fiber material unwound from the fiber unwinder 10 to the second guide roller assembly 30. The second guide roller assembly 30 guides the fiber material passing through the first guide roller assembly 20 to the third guide roller assembly 40. The third guide roller assembly 40 guides the fiber material passing through the second guide roller assembly 30 to the rotor core 1.

The first guide roller assembly 20 may include a first support and a first guide roller 21 rotatably provided on the first support. The first guide roller 21 may be formed in a cylindrical shape.

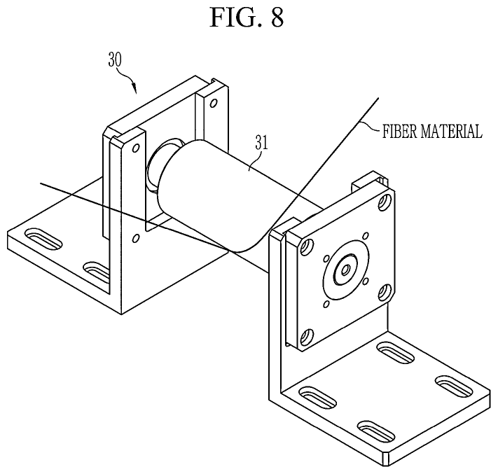

Referring to FIG. 8, the second guide roller assembly 30 may include a second support and a second guide roller 31 rotatably provided on the second support. The second guide roller 31 may be formed in a cylindrical shape. The second guide roller assembly 30 may be formed in the same shape as the first guide roller assembly 20.

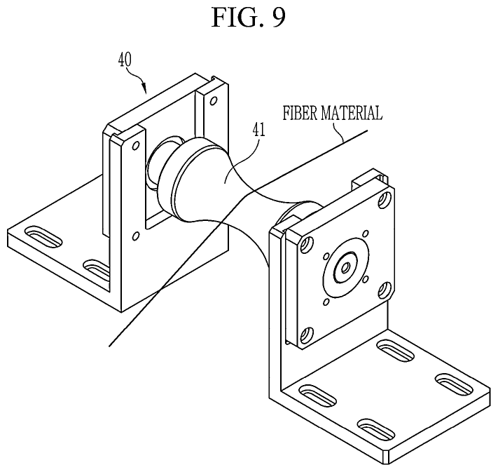

Referring to FIG. 9, the third guide roller assembly 40 may include a third support and a third guide roller 41 rotatably provided on the third support. The third guide roller 41 is formed in a substantially cylindrical shape and may be formed to be recessed toward a center. Expressed differently, the third guide roller 41 may be formed in a cylindrical shape whose diameter becomes smaller toward the center. When winding the fiber material around the outer surface of the rotor core 1, it is important to transport the fiber material from the fiber unwinder 10 to the exact position of the rotor core 1. Therefore, the center of the third guide roller 41 closest to the rotor core 1 is formed to be recessed so that the fiber material is positioned at the center of the third guide roller 41, so the fiber material may be transported to the exact position of the rotor core 1.

The tension roller assembly 50 may be provided between the plurality of guide rollers to measure the tension of the fiber material transported from the fiber unwinder 10 to the rotor core 1.

The tension roller assembly 50 may be disposed between the first guide roller 21 and the second guide roller 31.

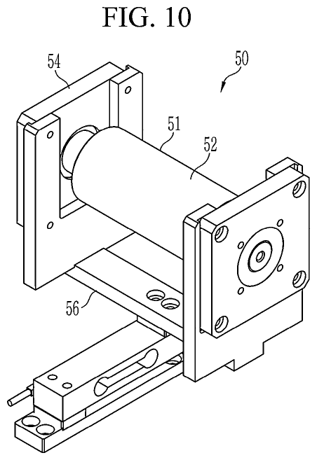

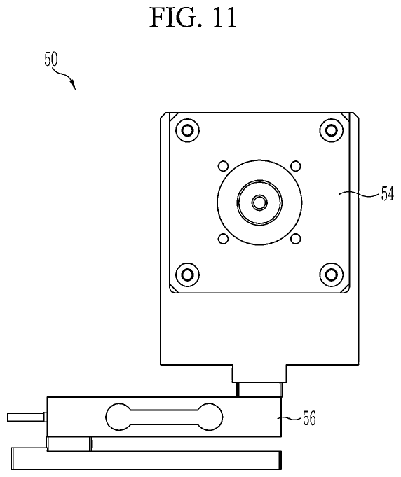

Referring to FIGS. 10 and 11, the tension roller assembly 50 may include a load cell 52 that measures the tension of the fiber material transported through the plurality of guide rollers. The tension roller assembly 50 may include a tension roller 51 that guides the fiber material. The tension roller assembly 50 may include side supports 54 supporting both sides of the tension roller 51. The tension roller assembly 50 may include a lower support 56 supporting the tension roller 51 and the side support 54 from a bottom.

The load cell 52 is provided inside the tension roller 51, and the tension of the fiber material measured by the load cell 52 is transmitted to a controller 100, which are described below.

The tension roller 51 is formed in a cylindrical shape and guides the fiber material passing through the first guide roller assembly 20 to the second guide roller assembly 30. The side support 54 rotatably supports the tension roller 51. The lower support 56 supports the tension roller 51 and the side support 54 from the bottom.

The tension roller 51 and the side support 54 are detachably assembled to the lower support 56. For example, the side support 54 and the lower support 56 may be detachably assembled through a fastener such as a bolt.

Depending on the type of rotor core 1, the tension roller assembly 50 may need to be mounted with a tension roller 51 having different widths or diameters. In this case, by replacing only the tension roller 51 and the side support 54 from the lower support 56, the tension roller 51 that may correspond to various fiber materials may be easily replaced.

In order to wind the outer surface of the rotor core 1 with the fiber material, it is necessary to wind the fiber material while moving the rotor core 1 in various directions.

To this end, the core support 60 may be provided so that the rotor core 1 is rotatable with respect to the core shaft, the rotor core 1 is movable in the axial direction of the core shaft, and the rotor core 1 is tilted with respect to the core shaft.

Referring to FIG. 12, the core support 60 may include a rotating device 70 that rotates the rotor core 1 with respect to the core shaft. The core support 60 may include a tilting device 80 that tilts the rotor core 1 with respect to the core shaft. The core support 60 may include a moving device 90 that moves the rotor core 1 along the core shaft.

The rotating device 70 may include a pair of shaft supports 71 that rotatably support both ends of the core shaft. The rotating device 70 may also include a first driving unit 75 that generates power to rotate the core shaft.

The core shaft is provided to pass through the center of the rotor core 1 and rotates integrally with the rotor core 1. The core shaft and the rotor core 1 rotate by the power generated from the first driving unit 75. The first driving unit 75 may be implemented with an electric motor.

The pair of shaft supports 71 may each include a guide bearing 73 that supports a lower portion of the core shaft. The pair of guide bearings 73 may be provided to support the lower portion of the core shaft.

The core support 60 may further include an upper support plate 61 on which the rotating device 70 is mounted. In other words, the rotor core 1 and the rotating device 70 that rotates the rotor core 1 with respect to the core shaft may be mounted on the upper support plate 61.

The tilting device 80 may include a hinge 81 that is provided under one side of the upper support plate 61. The tilting device 80 may include a cam block 83 that is provided under the other side of the upper support plate 61 and has a set inclination. The tilting device 80 may include a cam follower bearing 85 that is movably provided between the upper support plate 61 and the cam block 83. The tilting device 80 may include a second driving unit 87 that generates power to move the cam follower bearing 85.

In addition, the core support 60 may further include a lower support plate 63 on which the tilting device 80 is mounted.

The hinge 81 may be provided under one side of the upper support plate 61, so the upper support plate 61 may rotate with respect to a longitudinal direction of the core shaft about the hinge 81. In an embodiment, a lower portion of the hinge 81 may be fixedly installed on the lower support plate 63, and an upper portion of the hinge 81 may rotatably support the upper support plate 61.

The cam block 83 may be provided on the lower support 56 and may have an inclination set along the core shaft.

The cam follower bearing 85 may be movably provided between a tilted surface of the cam block 83 and the upper support plate 61. The inclination of the upper support plate 61 may be adjusted according to the movement of the cam follower bearing 85.

The second driving unit 87 generates power to move the cam follower bearing 85. The second driving unit 87 may be implemented with a hydraulic cylinder.

The moving device 90 includes a linear motion guide 91 on which the lower support plate 63 is fixedly mounted. The moving device 90 includes a linear motion block 93 on which the linear motion guide 91 is movably installed. The moving device 90 includes a third driving unit 95 that generates power to move the lower support plate 63 in the axial direction of the core shaft.

The linear motion guide 91 and the linear motion block 93 may be movably connected through bearings (not illustrated).

The third driving unit 95 may be implemented with an electric motor. A power conversion device is provided between the third driving unit 95 and the lower support plate 63 to convert a rotational motion of the third driving unit 95 into a linear motion. The power conversion device may be implemented with a ball screw, a rack and pinion device, etc.

Meanwhile, the winding apparatus of a rotor core according to an embodiment may further include a controller 100 that controls the drive motor 13 of the fiber unwinder 10 based on the tension of the fiber material measured in the tension roller assembly 50.

The controller 100 may be implemented with one or more processors that operate according to a set program. Program instructions programmed to perform each step of the winding method of the rotor core 1 according to the present disclosure through one or more processors are stored in the memory of the controller 100.

In addition, the controller 100 may control the operation of the first driving unit 75, the second driving unit 87, and the third driving unit 95 to wind the entire outer surface of the rotor core 1 with the fiber material. In other words, the controller 100 may control the first driving unit 75 to rotate the rotor core 1. The controller 100 may control the second driving unit 87 to tilt the rotor core 1 along the core shaft. The controller 100 may control the third driving unit 95 to move the rotor core 1 in the axial direction of the core shaft.

Hereinafter, the operation of the winding apparatus of a rotor core according to an embodiment is described in detail.

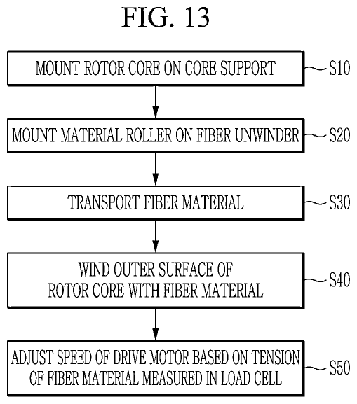

FIG. 13 is a flowchart for describing an operation of the winding apparatus of a rotor core according to the embodiment.

Referring to FIG. 13, the rotor core 1 is mounted on the core support 60 in order to wind the fiber material (S10).

The material roller 11 around which the fiber material is wound is mounted on the fiber unwinder 10 (S20).

When the material roller 11 around which the fiber material is wound rotates, the fiber material wound around the material roller 11 is transported to the first guide roller assembly 20 to the third guide roller assembly 40 while being unwound (S30).

The fiber material that has passed through the first guide roller assembly 20 and the second guide roller assembly 30 is supplied to the rotor core 1 and winds the outer surface of the rotor core 1 (S40).

In this case, the third guide roller 41 of the third guide roller assembly 40 has a shape recessed to the center, so the fiber material that has passed through the third guide roller 41 may be supplied to the exact position of the rotor core 1.

In addition, the rotor core 1 rotates with respect to the core shaft, is tilted with respect to the core shaft, and winds the entire outer surface of the rotor core 1 with the fiber material while moving along the core shaft.

In other words, when the first driving unit 75 operates, the rotor core 1, which rotates integrally with the core shaft, rotates.

When the second driving unit 87 operates, the upper support plate 61 rotates around the hinge 81 while the cam follower bearing 85 moves along the tilted surface of the cam block 83. As a result, the rotor core 1 mounted on the upper support plate 61 is tilted with respect to the core shaft.

When the third driving unit 95 operates, the linear motion guide 91 on which the lower support plate 63 is mounted moves along the linear motion block 93. As a result, the rotor core 1 mounted on the lower support plate 63 moves in the axial direction of the core shaft.

In this way, by appropriately moving, tilting, and rotating the rotor core 1, the entire outer surface of the rotor core 1 may be stably wound with the fiber material.

Meanwhile, the controller 100 may adjust the speed of the drive motor 13 of the fiber unwinder 10 based on the tension of the fiber material measured in the load cell 52 of the tension roller assembly 50 (S50).

For example, when the tension of the fiber material measured in the load cell 52 of the tension roller assembly 50 exceeds the set range, the speed of the drive motor 13 of the fiber unwinder 10 may be reduced to reduce the tension of the fiber material. On the contrary, when the tension of the fiber material measured in the load cell 52 of the tension roller assembly 50 is less than the set range, the speed of the drive motor 13 of the fiber unwinder 10 may be increased to increase the tension of the fiber material. Through this, the outer surface of the rotor core 1 may be wound with an appropriate tension of the fiber material.

According to the winding apparatus of a rotor core according to an embodiment, the surface tension of the rotor core 1 may be increased by winding the entire outer surface of the rotor core 1 with the fiber material of the appropriate tension, and the magnetic flux of the magnet 3 inserted into the electron core 1 may be prevented from leaking to the outside.

By minimizing the magnetic flux leaking from the rotor core 1, it is possible to increase the torque density of the motor and implement the high-performance motor.

Although embodiments of the present disclosure have been described above, the present disclosure is not limited thereto. The present disclosure can be variously modified within the scope of the claims, the detailed description of the present disclosure, and the appended drawings. It should be understood that various modifications also fall within the scope of the present disclosure.

### DESCRIPTION OF SYMBOLS

1: Rotor core
3: Magnet
10: Fiber unwinder
11: Material roller
12: Material rotation shaft
13: Drive motor
15: Material bearing
16: Bearing plate
17: Unwinder support
20: First guide roller assembly
21: First guide roller
30: Second guide roller assembly
31: Second guide roller
40: Third guide roller assembly
41: Third guide roller
50: Tension roller assembly
51: Tension roller
52: Load cell
54: Side support
56: Lower support
60: Core support
61: Upper support plate
63: Lower support plate
70: Rotating device
71: Shaft support
73: Guide bearing
75: First driving unit
80: Tilting device
81: Hinge
83: Cam block
85: Cam follow bearing
87: Second driving unit
90: Moving device
91: Linear motion guide
93: Linear motion block
95: Third driving unit
100: Controller

What is claimed is:

1. A winding apparatus of a rotor core, the winding apparatus comprising:
a fiber unwinder configured to unwind a fiber material for winding the rotor core;
a plurality of guide roller assemblies configured to guide the fiber material unwound from the fiber unwinder to the rotor core;
a tension roller assembly provided between the plurality of guide roller assemblies and configured to measure a tension of the fiber material; and
a core support configured to rotate the rotor core with respect to a core shaft, move the rotor core in an axial direction of the core shaft, and tilt the rotor core with respect to the core shaft.

2. The winding apparatus of claim 1, wherein the fiber unwinder includes:
a material roller rotatably provided on a material rotation shaft and wound with a fiber material;
a drive motor configured to rotate the material roller; and
a material bearing configured to support the material rotation shaft on both sides of the material rotation shaft.

3. The winding apparatus of claim 1, wherein the plurality of guide roller assemblies includes:
a first guide roller assembly provided downstream of the fiber unwinder and configured to guide the fiber material unwound from the fiber unwinder;
a second guide roller assembly provided downstream of the first guide roller assembly and configured to guide the fiber material passing through the first guide roller assembly; and
a third guide roller assembly provided downstream of the second guide roller assembly and configured to guide the fiber material passing through the second guide roller assembly to the rotor core.

4. The winding apparatus of claim 3, wherein:
a third guide roller of the third guide roller assembly is formed in a cylindrical shape whose diameter becomes smaller toward a center.

5. The winding apparatus of claim 3, wherein:
a tension roller assembly is provided between the first guide roller assembly and the second guide roller assembly.

6. The winding apparatus of claim 5, wherein:
the tension roller assembly includes a load cell configured to measure the tension of the fiber material.

7. The winding apparatus of claim 6, wherein the tension roller assembly includes:
a tension roller;
side supports configured to support both sides of the tension roller assembly; and
a lower support configured to support the tension roller assembly and each of the side supports from a bottom,
wherein the tension roller assembly and the side supports are detachably assembled to the lower support.

8. The winding apparatus of claim 1, wherein the core support includes:
a rotating device configured to rotate the rotor core with respect to the core shaft;
a tilting device configured to tilt the rotor core with respect to the core shaft; and
a moving device configured to move the rotor core along the core shaft.

9. The winding apparatus of claim 8, wherein the rotating device includes:
a pair of side supports configured to rotatably support both ends of the core shaft; and
a first driving unit configured to generate power to rotate the core shaft.

10. The winding apparatus of claim 9, wherein each of the side supports includes:
a guide bearing configured to rotatably support a lower portion of the core shaft.

11. The winding apparatus of claim 9, wherein the core support further includes:
a pair of side supports; and
an upper support plate on which the first driving unit is mounted.

12. The winding apparatus of claim 11, wherein the tilting device includes:
a hinge provided under a first side of the upper support plate;
a cam block provided under a second side of the upper support plate and including a set inclination;
a cam follower bearing movably provided between the upper support plate and the cam block; and
a second driving unit configured to generate power to move the cam follower bearing.

13. The winding apparatus of claim 12, wherein the moving device includes:
a linear motion guide, a lower support plate fixedly mounted on the linear motion guide, and the tilting device mounted on the lower support plate;
a linear motion block, the linear motion guide movably installed on the linear motion block; and
a third driving unit configured to generate power to move the lower support plate along the core shaft.

14. The winding apparatus of claim 1, wherein:
a rotational speed of a drive motor is adjusted based on the tension of the fiber material measured at the tension roller assembly.
